(19) United States
(12) Patent Application Publication
(10) Pub. No.: US 2012/0312758 A1
(43) Pub. Date: Dec. 13, 2012

(54) COMPOSITE MECHANICAL WATER FILTER MEDIA

(75) Inventor: Andrew Paxton, Taunton (GB)

(73) Assignee: INTERPET LTD, Surrey (UK)

(21) Appl. No.: 13/580,145

(22) PCT Filed: Mar. 11, 2011
(86) PCT No.: PCT/IB11/51043

§ 371 Date: Aug. 20, 2012

(30) Foreign Application Priority Data
Mar. 12, 2010 (GB) 1004094.7

(51) Int. Cl. B01D 39/02; B01D 24/02; C02F 1/00; B01D 39/04

(52) U.S. Cl. 210/786; 210/503; 210/263; 210/807

(57) ABSTRACT

Water filters require filter media which may be a substantially single structure such as open-cell foam, or comprised of a plurality of relatively small elements. The present invention provides composite mechanical water filter media for use in mechanical water filters comprising a plurality of first elements having a first shape and a plurality of second elements having a second shape, the first and second shapes being substantially different from one another, the elements being arranged to interlock with one another.

### FIELD OF THE INVENTION

The present invention relates generally to composite mechanical water filter media, to a water filter comprising such filter media and to a method of operating a water filer comprising such filter media and finds particular, although not exclusive, utility in pond and aquaria water filters.

### BACKGROUND OF THE INVENTION

The water in ponds and aquaria tends to become dirty over time due to an accumulation of algae and other debris. Accordingly, water filters are known which include a chamber including filter media. The filter media may comprise open cell foam, sand, or other elements some, or all, of which may be substantially inert relative to the water. The water is continuously passed through the filter chamber, and hence the filter media, such that the debris is substantially removed from it. This may be by mechanical, biological, chemical or bio-chemical action.

It is known to provide spherical-like filter media which encourage bio-filtration of pond water. This is where bacteria may reside on the media and consume, or treat, unwanted elements within the pond water. However, these spheres quickly become choked with sediment and the like if no mechanical filtering step is undertaken prior to the water reaching them.

Mechanical filters also, over time, accumulate debris and other unwanted elements reducing the efficiency of the filter media such that either the exiting water remains dirty or such that the filter media becomes effectively blocked. This results in water overflowing, or by-passing, the filter media. Alternatively, or additionally, the flow-rate through the filter media may become reduced due to back-pressure created in the system. When this occurs the filter media needs to be cleaned.

There are several different ways in which filter media may be cleaned. One way is to remove the filter media and wash it. This is relatively easy for filter media such as blocks of open cell foam, however, such media is typically cleaned with tap water which can include chemicals such as chlorine and the like which may be harmful to bacteria and other pond life. Another way is to effect a temporary cleaning cycle wherein the flow of water is reversed through the chamber. Clean water is used and redirected away from the pond after exiting the filter.

These methods do provide some cleaning of the filter media but where it is comprised of a plurality (possibly a multitude) of discrete elements it is time consuming and difficult for a user to remove them from the chamber and wash them. Moreover, the discrete elements tend to clump together into a “block” due to the accretion of debris such that cleaning using the reverse flow technique is inefficient and/or incapable of being effective.

Filter media which are comprised of a plurality of discrete elements are known, however, each element is the same shape. Alternatively, filter media which comprise a plurality of elements each having a unique shape are known, such as sand or gravel.

It has been found that such filter media has certain drawbacks such as the media elements being so densely packed (as in sand) that the flow rate through the filter is severely reduced, that the pore spaces between the media elements is too large and therefore ineffective, or that the pore spaces are irregular such that “channelling” or “tracking” occurs. In this regard these terms describe the situation where open channels are created through the filter media which allow the water to pass entirely through relatively quickly without significant filtering occurring. Another problem is that the media elements may not separate effectively during a cleaning cycle of the filter such that they remain in one or more blocks. Accordingly cleaning of the elements to remove the accumulated debris/filter residue is ineffective.

Accordingly, it is desirable to provide improved filter media which interlock to provide efficient mechanical filtering of water, yet are relatively easily separated during a cleaning cycle.

### BRIEF SUMMARY OF THE INVENTION

In a first aspect, the invention provides composite mechanical water filter media for use in mechanical water filters comprising a plurality of first elements having a first shape and a plurality of second elements having a second shape, the first and second shapes being substantially different from one another, the elements being initially separate and being arranged to releasably interlock with one another.

The term “mechanical” defines the media as primarily acting in a non-chemical, non-biological and non-biochemical way. In other words, the filter media is acting primarily as a sieve to trap particulates within the water; it may promote or effect biological or chemical treatment of the water, but this is not its main purpose.

The term “interlock” may take its usual meaning in that the elements become interwoven or intertwined such that they form a conglomerate of elements. In use, a collection of such elements may be forced to the top of a filter chamber in a water filter by the pressure of the incoming water from below. The water may then exit the chamber through an outlet at the top of the chamber. A grid, or other such means, may be provided at the top of the chamber to prevent the elements leaving the chamber.

The mass of elements remain substantially stationary relative to one another when interlocked in use and when filtering water. However, in a reverse flow situation for cleaning of the filter, the elements may be separable from one another. This is partly because the volume of the chamber in which the elements may move is larger than the total volume of elements. If the elements are buoyant then during a reverse flow situation they are pushed downwards by the water entering at the top of the chamber but will also tend to rise when possible. This action allows for the elements to move relative to one another to effect their cleaning.

The filter media may further comprise a plurality of third elements having a third shape being substantially different from both of the first and second shaped elements, the first, second and third elements being initially separate and being arranged to releasably interlock with one another.

The water filter is primarily a mechanical type filter; the interlocking nature of the different shaped elements providing a complex filter with no direct or substantially direct channels or routes from one side to the other for the water to pass along. Rather, the water has to travel along a tortuous, meandering route to exit the filter chamber. This provides a sufficient residence time for undesirable particles suspended in the water to “drop out” and/or be retained within, or between the elements.

The filter media elements may be comprised of artificial materials. For instance, the filter media may be comprised of extruded and/or injection moulded plastics. The plastics may be food grade. Other materials are contemplated such as metals, glass, and ceramics.

The filter media elements are non-spherical.

Each of the plurality of first, second and third elements may respectively be substantially uniform in shape and appearance.

Each element may have a dimensional length less than approximately 10 mm in any one axis. Accordingly, the elements may be considered to be relatively small. This may allow for the spacing between adjacent first, second and third elements, when interlocked, to be approximately 4 mm, although other spacing such as 1, 2, 3 or 5 mm is possible. This is small enough to prevent relatively large particles of undesirable material, such as algae, to pass out of the filter matrix.

The first shape may be approximately rectilinear, for instance similar to a Roman letter “I” (sans serif). The second shape may be approximately curvilinear, for instance a portion of a circle, possibly a semi-circle and possibly similar to a Roman letter “C” (sans serif). The third shape may have three arms, each arm being approximately rectilinear, the three arms arranged approximately in the shape of the Roman letter “H” (sans serif). For instance, two arms may be arranged substantially parallel to one another and spaced apart, connected together by a third arm arranged substantially perpendicular to the other two straight arms, all arms lying substantially in the same plane as one another. These three shapes allow relatively tight interlocking of the various elements during filtering but allow for them to break apart during a filter element cleaning process.

Although the first, second and third shapes have been defined as similar to the Roman letters “I”, “C” and “H” respectively it is possible that they have a different order such that the first shape is similar to the Roman letter “C”, the second shape is similar to the Roman letter “H” and so on.

Each element may comprise a support and an array (or plurality) of blade-like members projecting from the support. Each blade-like member may have a projection distance from its support of less than or equal to 3 mm. The blade-like members aid retention of the fine material within the water and may act like a sieve. The blade-like members of one element may become releasably interlocked with those of another.

In a second aspect, the invention provides a water filter comprising a chamber through which water may be passed for filtering, the chamber including a plurality of filter media according to the first aspect and as described and/or claimed herein. The water filter may be a pond or aquaria water filter.

In this regard, the term “a plurality” may be in excess of one hundred, in excess of two hundred, in excess of three hundred, in excess of four hundred, or even in excess of one thousand.

In a third aspect, the invention provides a method of operating a water filter comprising the steps of providing a water filter according to the second aspect, wherein the chamber includes a volume of interlocked filter elements which is equivalent to more than 30% of the volume of the chamber; in a filtering step, arranging for dirty water to enter the chamber, and for cleaned water to exit the chamber after passing through the interlocked filter elements whereby detritus carried by the initially dirty water is trapped by the filter media; wherein the quantity and shape of the differently shaped elements are such that the elements remain substantially static relative to one another; and in a cleaning step, arranging for water to enter the chamber, and for that water to exit the chamber, after passing through the filter media, carrying at least some of the detritus that has been trapped in the filter media during the filtering step; wherein the quantity and shape of the differently shaped elements are such that the elements are substantially suspended and non-static relative to one another.

The cleaning step is therefore one which may rely on at least hydraulic action of the water to agitate the elements.

The volume of interlocked filter elements may be more than 40%, 50%, 60%, 70%, or 80% of the volume of the chamber within which they may freely move during the cleaning step.

When suspended during the cleaning step the filter elements may move around within the chamber due to water flow and/or mechanical agitation such that collisions occur between elements thus aiding the cleaning process.

The elements may be buoyant.

The method may include the step of mechanically agitating the filter media in the cleaning step by means of filaments or paddles. In other words, the mechanical agitation may be aided by non-hydraulic means. The filaments may be substantially rigid and moved within the chamber, from outside the chamber, to cut up the block of dirty elements.

The water entering and exiting the filter chamber during the filtering step may originate from, and be returned to, a pond. The water entering the filter chamber during the cleaning step may originate from the pond. The dirty water, carrying the detritus with it, may be directed away from the pond. The water entering the filter chamber during the cleaning step may originate from another source such as a water butt, a drinking water (potable) supply or any combination of these and the pond water.

### BRIEF DESCRIPTION OF THE DRAWINGS

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

FIGS. 1 to 3 are three elevational views along the three major orthogonal axes of a first embodiment of a filter media element according to the invention;

FIGS. 4 and 5 are two elevational views along two of the three major orthogonal axes of a second embodiment of a filter media element according to the invention;

FIGS. 6 and 7 are two elevational views along two of the three major orthogonal axes of a third embodiment of a filter media element according to the invention;

FIG. 8 is view of a collection of media filter elements; and

FIG. 9 is perspective view of a water filter.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn to scale for illustrative purposes. The dimensions and the relative dimensions do not correspond to actual reductions to practice of the invention.

### DETAILED DESCRIPTION OF THE INVENTION

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may refer to different embodiments. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some features included in other embodiments, combinations of features of different embodiments are meant to be within the scope of the invention, and form yet further embodiments, as will be understood by those skilled in the art. For example, in the following claims, any of the claimed embodiments can be used in any combination.

In the description provided herein, numerous specific details are set forth. However, it is understood that embodiments of the invention may be practised without these specific details. In other instances, well-known methods, structures and techniques have not been shown in detail in order not to obscure an understanding of this description.

In the discussion of the invention, unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

The invention will now be described by a detailed description of several embodiments of the invention. It is clear that other embodiments of the invention can be configured according to the knowledge of persons skilled in the art without departing from the true spirit or technical teaching of the invention, the invention being limited only by the terms of the appended claims.

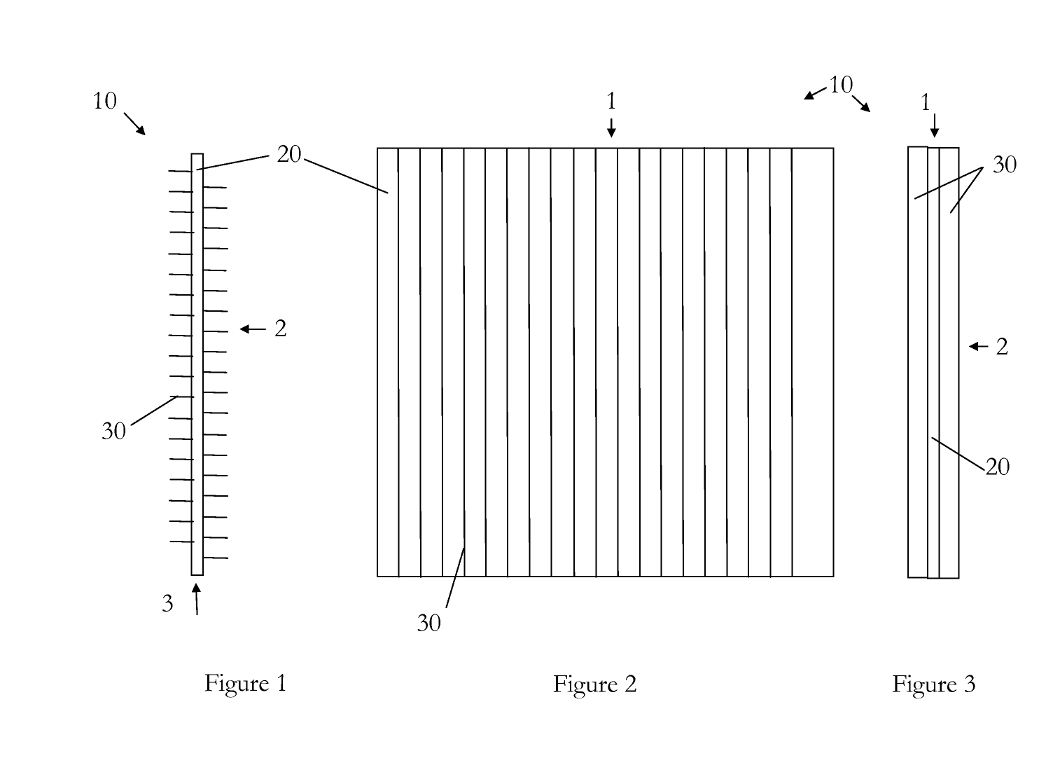

A first embodiment of a possible filter media element 10 is shown in FIGS. 1 to 3. FIG. 1 is an end-on view showing a rectilinear and relatively thin central support 20 from which a multitude of blade-like members 30 extend perpendicularly away. The arrow referenced “2” indicates the view shown in FIG. 2.

The FIG. 2 view is an elevational side view of the element 10. The central support 20 is seen to be planar and rectangular. Across each of the two opposite major surfaces the blade-like members 30 are arranged in parallel rows. The arrow referenced “1” indicates the view shown in FIG. 1. The arrow referenced “3” indicates the view shown in FIG. 3.

FIG. 3 is an end-on view from an orthogonal position to that shown in FIG. 1. The central support 20 is rectilinear and relatively thin. Only two blade-like members 30 are visible extending perpendicularly away from the central support, one on either side. The other blade-like members 30 are obscured by the two shown as they are located behind them. The arrow referenced “1” indicates the view shown in FIG. 1 and the arrow referenced “2” indicates the view shown in FIG. 2.

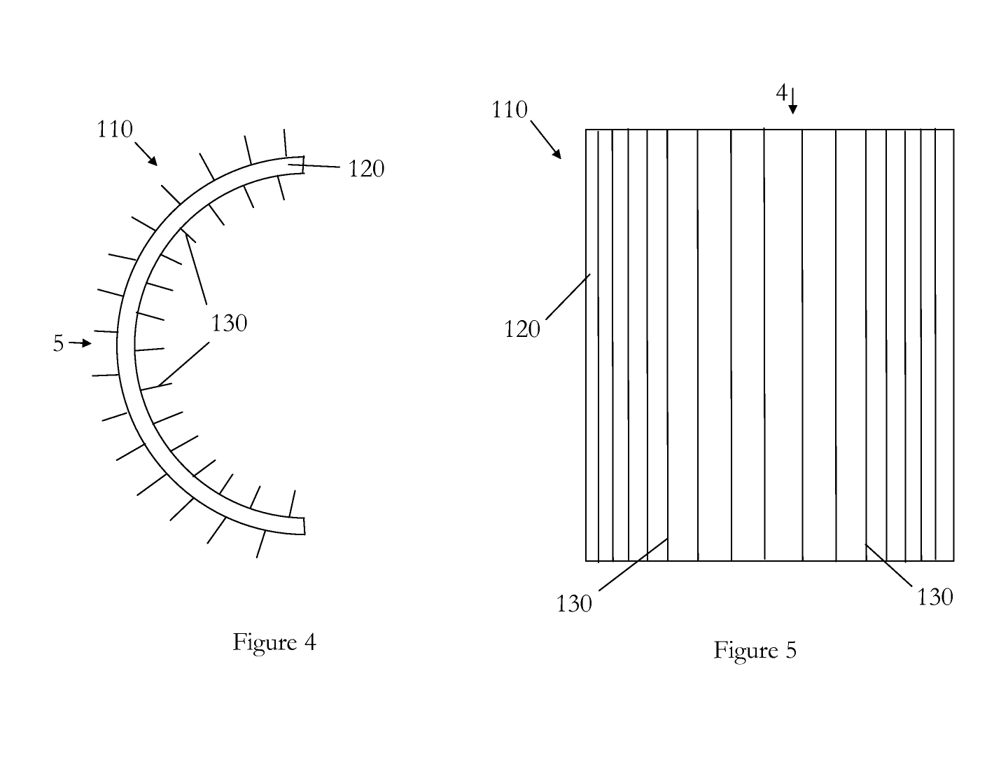

A second embodiment of a possible filter media element 110 is shown in FIGS. 4 and 5. FIG. 4 is a plan view showing a curvilinear and relatively thin central support 120 from which a multitude of blade-like members 130 extend perpendicularly away. The arrow referenced “5” indicates the view shown in FIG. 5. The element 110 has a shape in plane approximate to a Roman letter “C” in that it is a portion of a cylinder, possibly hemi-cylindrical in shape.

FIG. 5 shows an elevational side view of the element 110 as seen from the direction of the arrow referenced “5” in FIG. 4. The central curvilinear support 120 is shown together with the blade-like members 130 arranged in parallel rows across its surface. The arrow referenced “4” indicates the view shown in FIG. 4.

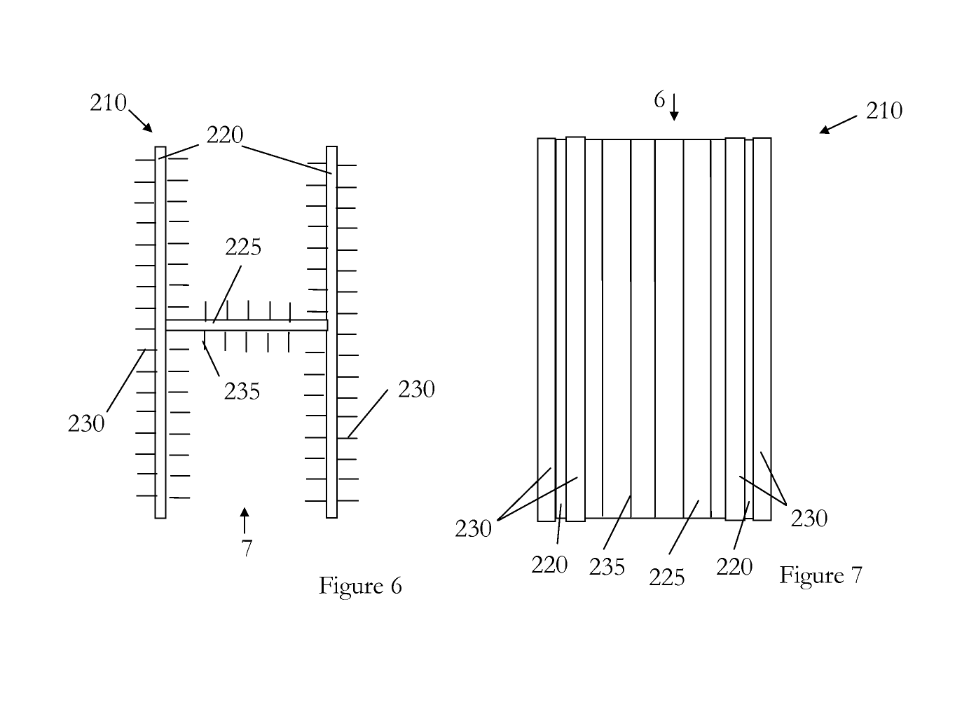

A third embodiment of a possible filter media element 210 is shown in FIGS. 6 and 7. FIG. 6 is a plan view showing two rectilinear and relatively thin supports 220 arranged in parallel and spaced apart by a middle third rectilinear thin support 225 such that the overall arrangement is in the form of a Roman letter “H”. Each support 220 has a multitude of blade-like members 230 extending perpendicularly away from its sides. Furthermore, the central support 225 has a multitude of blade-like members 235 extending perpendicularly away from each side.

FIG. 7 shows an elevational side view of the element 210 as seen from the direction of the arrow referenced “7” in FIG. 6. The middle third support 225 is shown together with the blade-like members 235 arranged in parallel rows across its surface. The other two supports 220 are shown, one at either end of the middle third support 225. On either side of each support 220 a blade-like member 230 is shown projecting outwardly. Other blade-like members 230 are not shown because they are behind and therefore obscured by the members shown. The arrow referenced “6” indicates the view shown in FIG. 6.

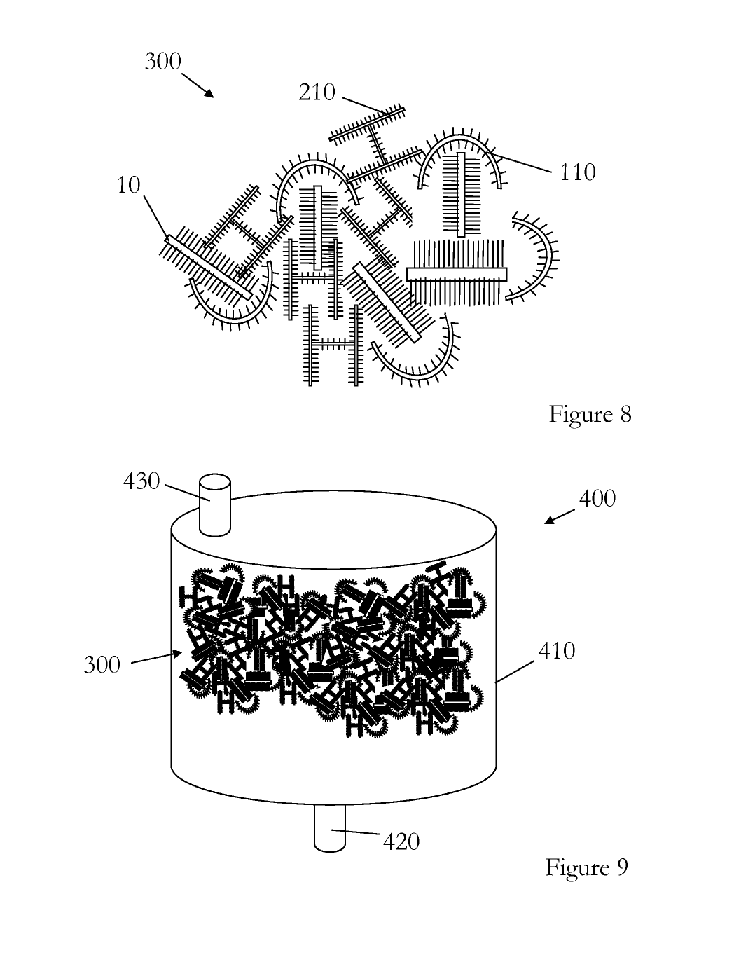

A collection 300 of elements 10, 110, 210 are shown in FIG. 8. It is to be noted that due to the different shapes of the three different types of elements interlocking between them occurs.

A mass 300 of such interlocking elements is shown within a filter chamber 410 of a water filter 400. The chamber 410 includes a water inlet 420 and outlet 430. In use, the dirty water enters the chamber 410 via inlet 420, passes through the mass 300 of elements and exits via outlet 430. During its passage through the mass 300 of elements the water is substantially cleaned by means of any particulate matter being trapped between the individual elements 10, 110, 210 and/or in between the blade-like members 30, 130, 230, 235 arranged on the surfaces of the individual elements 10, 110, 210.

The mass 300 of interlocking elements 10, 110, 210 provides a tortuous route for the water to travel along and prevents “channelling”.

Although the three different types of elements 10, 110, 210 have been described with reference to the Figures herein it is to be understood that other shaped elements are contemplated either in combination with, or in place thereof. For instance, although the third shaped element 210 is described as having a shape like a Roman letter “H” in plan, the element could have a shape like a Roman letter “h” or indeed any other letter.

Other features which the elements 10, 110, 210, may include are the central supports 20, 120, 220, 225 having perforations, the blade-like elements 30, 130, 230, 235 being discontinuous along their lengths, and different arrangements of the blade-like elements 30, 130, 230 , 235 on the surfaces of the supports 20, 120, 220, 225 such as random and non-parallel.

Each blade-like member 30, 130, 225, 230, 235 may be approximately 1 mm in length (measured perpendicularly from its support 20, 120, 220). Other lengths such as 2, 3, 4, 5, 6, 7, 8, 9 or even 10 mm are also contemplated. Each support 20, 120, 220 may have a thickness of approximately 1 to 2 mm, although other thicknesses such as in the range 2 to 5 mm are contemplated.

What is claimed is:

1. Composite mechanical water filter media for use in mechanical water filters comprising a plurality of first elements having a first shape and a plurality of second elements having a second shape, the first and second shapes being substantially different from one another, the elements being initially separate and being arranged to releasably interlock with one another.

2. The filter media of claim 1, further comprising a plurality of third elements having a third shape being substantially different from both of the first and second shaped elements, the first, second and third elements being initially separate and being arranged to releasably interlock with one another.

3. The filter media of claim 1 being comprised of artificial materials.

4. The filter media of claim 3 being comprised of extruded and/or injection moulded plastics.

5. The filter media of claim 4, wherein the plastics is food-grade plastics.

6. The filter media of claim 1, wherein each element has a dimensional length less than approximately 10 mm in any one axis.

7. The filter media of claim 1, wherein the spacing between adjacent first, second and third elements when interlocked is approximately 4 mm.

8. The filter media of claim 1, wherein the first shape is approximately rectilinear.

9. The filter media of claim 1, wherein the second shape is approximately curvilinear.

10. The filter media of claim 1, wherein the third shape has three arms, each arm being approximately rectilinear, the three arms arranged approximately in the shape of the Roman letter “H”.

11. The filter media of claim 1, wherein each element comprises a support and an array of blade-like members projecting from the support.

12. The filter media of claim 11, wherein each blade-like member has a projection distance from its support of less than or equal to 3 mm.

13. A water filter comprising a chamber through which water may be passed for filtering, the chamber including a plurality of filter media according to claim 1.

14. The water filter of claim 13 being a pond or aquaria water filter.

15. A method of operating a water filter comprising the steps of providing a water filter according to claim 13, wherein the chamber includes a volume of interlocked filter elements which is equivalent to more than 30% of the volume of the chamber; in a filtering step, arranging for dirty water to enter the chamber, and for cleaned water to exit the chamber after passing through the interlocked filter elements whereby detritus carried by the initially dirty water is trapped by the filter media; wherein the quantity and shape of the differently shaped elements are such that the elements remain substantially static relative to one another; and in a cleaning step, arranging for water to enter the chamber, and for that water to exit the chamber, after passing through the filter media, carrying at least some of the detritus that has been trapped in the filter media during the filtering step; wherein the quantity and shape of the differently shaped elements are such that the elements are substantially suspended and non-static relative to one another.

16. The method of claim 15, including the step of mechanically agitating the filter media elements in the cleaning step by means of filaments or paddles.

17. The method of claim 15, wherein the water entering and exiting the filter chamber during the filtering step originates from, and is returned to, a pond or aquaria.

18. The method of claim 17, wherein the water entering the filter chamber during the cleaning step originates from the pond or aquaria.
